(19) United States
(12) Patent Application Publication
(10) Pub. No.: US 2022/0340002 A1
(43) Pub. Date: Oct. 27, 2022

(54) FLUID CONTAINER

(71) Applicant: Stewart Thompson, Strathmore, VIC (AU)

(72) Inventor: Stewart Thompson, Strathmore, VIC (AU)

(21) Appl. No.: 17/753,596

(22) PCT Filed: Sep. 16, 2020
(86) PCT No.: PCT/AU2020/000105

§ 371 Date: Mar. 9, 2022

(30) Foreign Application Priority Data
Sep. 17, 2019 (AU) 2019903458

(51) Int. Cl. B60K 15/063; B60R 9/055; B60K 15/077

(52) U.S. Cl. CPC B60K 15/063; B60R 9/055; B60K 15/077; B60K 2015/0639

(57) ABSTRACT

Disclosed herein is a fluid container for a vehicle, the fluid container having at least one passageway which extends therethrough between opposing faces of the fluid container, the at least one passageway being configured to be attachably mounted on the vehicle and wherein the or each passageway internal to the fluid container is configured to inhibit movement of the fluid contained therein.

### RELATED APPLICATIONS

This application claims priority to Australian provisional application no. 2019903458 filed 17 Sep. 2019, the entire content of which is incorporated herein by reference.

### FIELD OF THE INVENTION

This invention relates to a fluid container for mounting on a vehicle. In particular, the fluid container is for containing auxiliary water or even fuel mountable to off-road vehicles.

### BACKGROUND OF THE INVENTION

To travel from one destination to another in vast areas which are sparsely populated, such as outback Australia, it may be necessary to use an off-road vehicle such as a four-wheel drive vehicle. In particular, off-road vehicles are commonly used in extended trips in remote and rough terrain for touring and recreation purposes or for expedition purposes in exploring unknown or off-road areas. It can be necessary for the passengers in the vehicle to be self-supported for extended periods requiring considerable quantities of supplies and equipment.

These trips may also require that large amounts of fluids are carried such as water if none is easily or locally available. In addition, large amounts of fuel may be required for a trip where large distances must be covered or it is not possible to re-fuel from external sources. In such cases, a backup reserve quantity of fuel and/or water must also be anticipated to avoid being stranded.

It is also generally undesirable to transport fluid fuels, such as diesel, kerosene and petrol, in the cabin of a vehicle which can limit the amount and location of the fuel to be carried. Fumes may vent from a container which can affect the occupants and further produce an explosive fuel and air mixture which may explode when exposed to an ignition source, injuring or even killing the occupants.

Jerrycans are common containers used for transporting fuel or water which are often made of steel but can also be made of polyethylene. Jerrycans can be carried in dedicated jerrycan holders such as at the rear of a vehicle however this limits the amount of fuel that can be carried. These jerrycans can also be carried on the rooftops of four-wheel drive vehicles. However as fully laden jerrycans can weigh up to 20 kg and are typically manually handled moving these containers to and from the rooftop can be potentially awkward, difficult and even injurious. There are similar disadvantages with large water containers which must be manually handled to arid from a roof top.

Furthermore, jerrycans or water containers are generally kept upright to avoid spillage and therefore this can raise the centre of gravity which adversely affects vehicle handling and stability. Also increasing the profile of the vehicle overall can lead to increased drag and therefore increase fuel consumption when travelling, especially at high speeds.

Another downside to jerrycans or large water containers is the difficulties in fluid transfer which due to the weight of the jerrycan or water container is messy or dangerous. In particular, manual fuel transfer can lead to fuel contamination in dusty or wet conditions. Manual handling of the jerrycans or water containers also means that they can be vulnerable to damage from dropping or knocks which can lead to unnoticed fuel or water leakage which may leave the passengers stranded without sufficient fuel or water. Constant examination of the jerrycans or water containers over the duration of the trip may be required to avoid being stranded. Water containers in particular are generally made of thin-walled polyethylene and therefore may be more vulnerable to damage.

Another method for carrying additional fuel is to install auxiliary long-range fuel tanks however this can be expensive as the tanks often have to be customised to a vehicle and require complex fittings and internal baffles to avoid the fuel sloshing around. Other disadvantages include that as the most convenient place for auxiliary tanks may be under the vehicle, this may affect the vehicle's ground clearance and require the use of a pump to get the fuel from the auxiliary tank to the main tank adding to costs. Furthermore installation of auxiliary tanks may assist in carrying fuel or water, such as tanks which are mounted underneath the vehicle, but does not assist in carrying substantial amounts of other or additional fluids which may be needed.

Examples of the invention seek to solve or at least ameliorate one or more disadvantages of previous methods and devices for carrying quantities of fluids such as water or fuel on a four-wheel drive vehicle.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

According to an aspect of the present invention there is provided a fluid container for a vehicle, the fluid container having at least one passageway which extends therethrough between opposing faces of the fluid container, the at least one passageway being configured to be attachably mounted on the vehicle and wherein the or each passageway internal to the fluid container is configured to inhibit movement of the fluid contained therein.

According to another aspect of the present invention there is provided a fluid container for a vehicle, the fluid container having at least one passageway which extends therethrough between opposing faces of the fluid container, the at least one passageway being configured to receive mounting means for attachably mounting the fluid container on the vehicle and wherein the or each passageway internal to the fluid container is configured to inhibit movement of the fluid contained therein.

The or each passageway may be elongated to form a slotted passageway which has a wall internal to the container thereby forming at least one baffle to inhibit movement of the fluid from one side of the baffle to the other. When the fluid container is so mounted, at least one baffle may be arranged to inhibit movement of the fluid substantially parallel to the direction of travel. More preferably, or alternatively, the at least one baffle may be arranged to inhibit movement of the fluid substantially transverse to the direction of travel.

In a preferred embodiment, the fluid container may have at least two spaced-apart baffles, adjacent ones of which are oriented in transverse directions to inhibit movement of the fluid both transverse and parallel to the direction of travel.

Preferably, when the container is mounted on a roof of the vehicle, the or each passageway is vertically oriented for receiving fastening means for engageable mounting on the vehicle.

The fastening means may comprise male components threadably receivable in female components of a rack or platform mounted on the roof or vice versa. In an alternate embodiment the fastening means may be a U-bolt which is configured to attach the container to a roof bar or a portion of the rack or platform.

Preferably, the or each passageway is configured to hold a washer member configured to allow the fastening means to securely mount the fluid container via the or each passageway to the vehicle. The washer member can have a slot for adjustable positioning of the fastening means. An upwardly directed opening of the or each passageway can be recessed for seating the washer member.

The container may have an outlet for dispensing said fluid therefrom and an inlet for allowing fluid to be received therein. The outlet may be adapted to connect to a hose. The outlet can include a valve for on-demand dispensing of the fluid. The inlet may be arranged to receive a cap.

The fluid container is preferably configured to contain potable water. Alternatively, the fluid container may be configured to contain fuel. The fluid container can contain fluids other than water or fuel.

The container can have attachment points for attachably mounting equipment. Preferably, the equipment includes recovery boards as an example but can include camping equipment, supplies, jacks or other items.

According to yet another aspect of the present invention, there is a fluid container for a vehicle, the fluid container having at least one passageway which extends therethrough between opposing faces of the fluid container, wherein the or each passageway internal to the fluid container is configured to inhibit movement of the fluid contained therein and wherein the body of the container has at least one attachment point for attachably mounting equipment thereto.

The fluid container can have an outer surface configured to reduce drag.

The surface of the fluid container can be adapted so as to form a recess for receiving equipment. In a particularly preferred embodiment, the surface is adapted to form a recess for fittably receiving recovery boards. The fluid container and the equipment when so received in the recess can form a profile configured to reduce drag.

### BRIEF DESCRIPTION OF THE DRAWINGS

The present invention will now be described, by way of non-limiting example, with reference to the accompanying drawings in which:

FIGS. 1 and 2 are perspective and plan views respectively of a fluid container according to a preferred embodiment of the present invention; and

FIGS. 3 to 5 are wireframe front, side and rear views respectively of the fluid container of FIGS. 1 and 2;

FIG. 6 is a plan view of the fluid container of FIGS. 1 to 5 having fastening means received in longitudinally oriented passageways;

FIG. 7 is a plan view of the fluid container of FIGS. 1 to 5 having fastening means received in transversely oriented passageways;

FIG. 8 is a close-up view of one of the mountings of FIG. 7;

FIG. 9 is a cross-section view of the fluid container of FIGS. 1 to 8;

FIG. 10 is a front view of the fluid container having a pair of recovery boards mounted thereon;

FIG. 11 is a perspective view of the fluid container of FIG. 10 mounted on a rooftop platform;

FIG. 12 is a rear perspective view of the fluid container of FIGS. 1 to 9 mounted on the rooftop platform;

FIG. 13 is a front perspective view of an alternative fluid container according to another preferred embodiment of the invention configured to hold a pair of recovery boards;

FIG. 14 is a front close-up view of an alternative mounting in a fluid container of FIGS. 1 to 5; and

FIG. 15 is a perspective view of the alternative mounting of FIG. 14.

### DETAILED DESCRIPTION OF THE INVENTION

Preferred features of the present invention will now be described with particular reference to the accompanying drawings. However, it is to be understood that the features illustrated in and described with reference to the drawings are not to be construed as limiting on the scope of the invention.

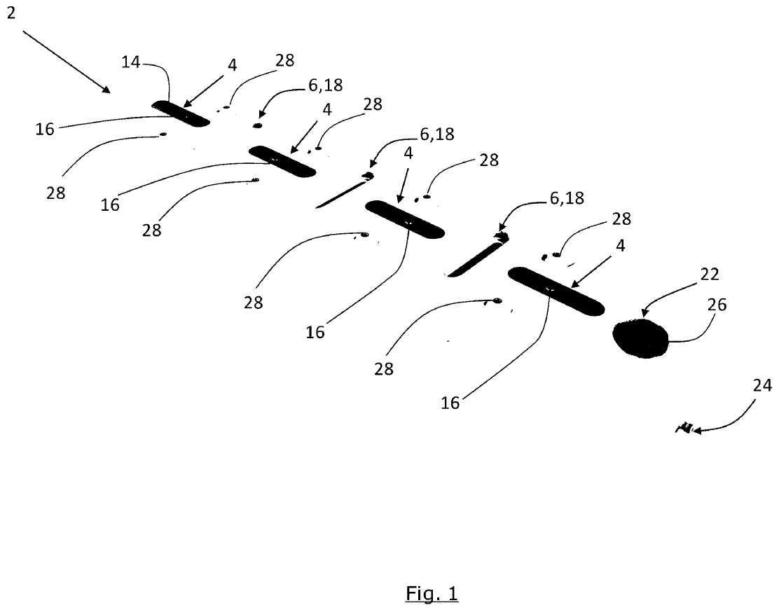

In FIGS. 1 to 15 are various views of a fluid container 2 for a vehicle according to a preferred embodiment of the invention. Although the fluid container 2 is described below as being mounted on a four wheel drive vehicle, it will be appreciated that embodiments of the invention could be mounted on a variety of vehicles, such as utility vehicles, caravans or even boats.

The fluid container 2 has a number of passageways 4, 6 (in particular seven passageways) which extend through the fluid container 2 between opposing faces. In the embodiment illustrated the passageways 4, 6 extend between the upper and lower surfaces however it can be understood that the passageways 4, 6 could extend between other faces, such as the side faces. The wall defining each passageway 4, 6 internal to the fluid container 2 is configured to inhibit movement of the fluid. Specifically the internal passageway wall or walls define a baffle 8, 10 which inhibits movement of the fluid and suppresses sloshing effects. Sloshing generates dynamic forces which can influence the behaviour of the vehicle and affects its stability and control, especially during braking and turning, and as well as potentially increasing fuel consumption. Thus the baffle 8, 10 reduces the fluid movement and therefore promotes greater control and stability of the vehicle, and also decreases fuel consumption.

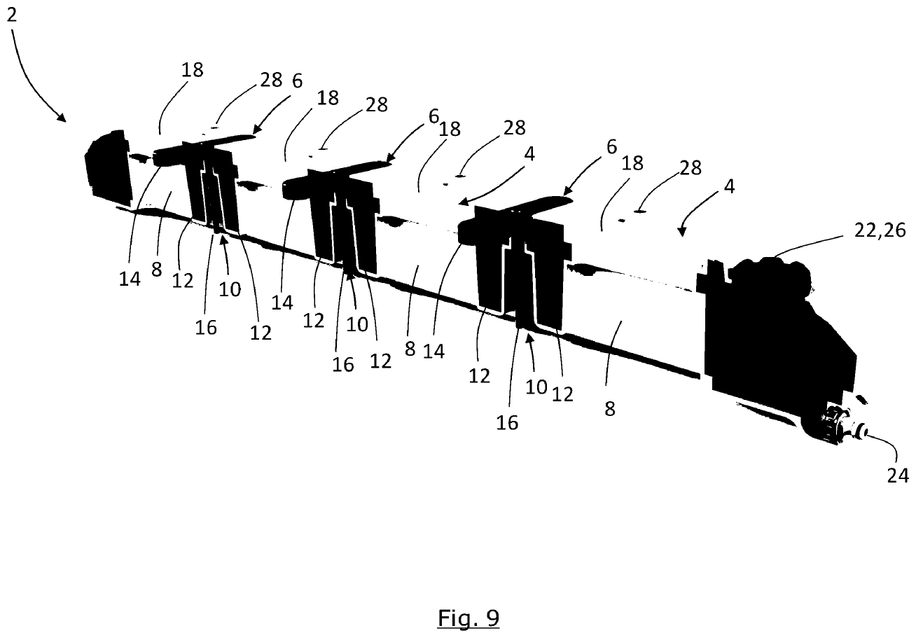

It is preferred, as illustrated particularly in FIG. 9, that the passageways 4, 6 are elongated in one dimension so as to form slotted passageways 4, 6. The baffles 8, 10 defined by the slotted passageway walls extend intermediate to opposing internal walls of the container thereby preventing fluid movement from one side of the baffle 8, 10 to the other except via two openings 12 which are defined by the end portions of the baffles 8, 10 and the opposing container walls. It can be appreciated that greater the relative size of the baffles 8, 10 the smaller the openings 12 which further inhibits fluid movement. In an exemplary embodiment illustrated in FIG. 9, the baffles 8, 10 block about 75% of the cross-sectional area of the fluid container 2 however the baffles 8, 10 can be configured so as to block up to 90% of the cross-sectional area. In a more preferred embodiment the baffles 8, 10 are configured to block up to 95% of the cross-sectional area.

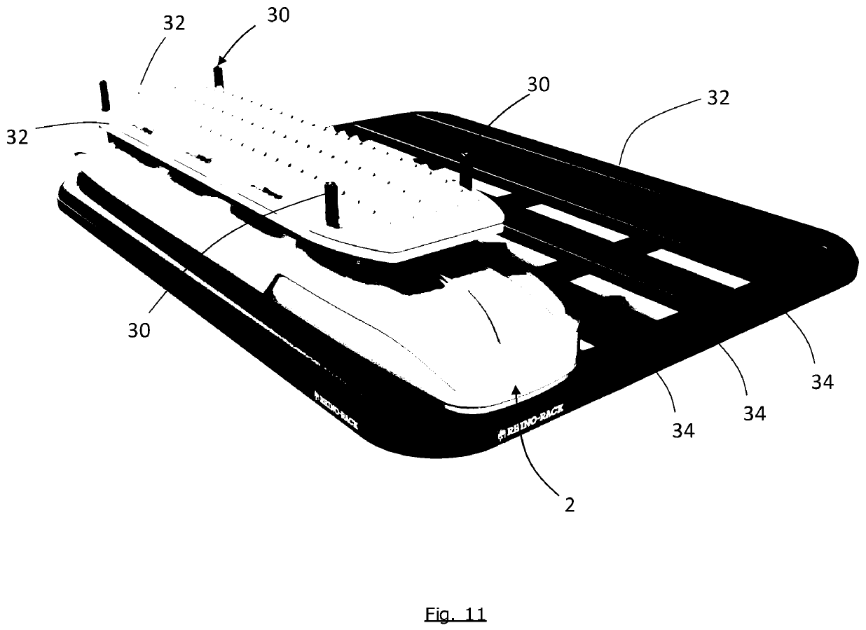

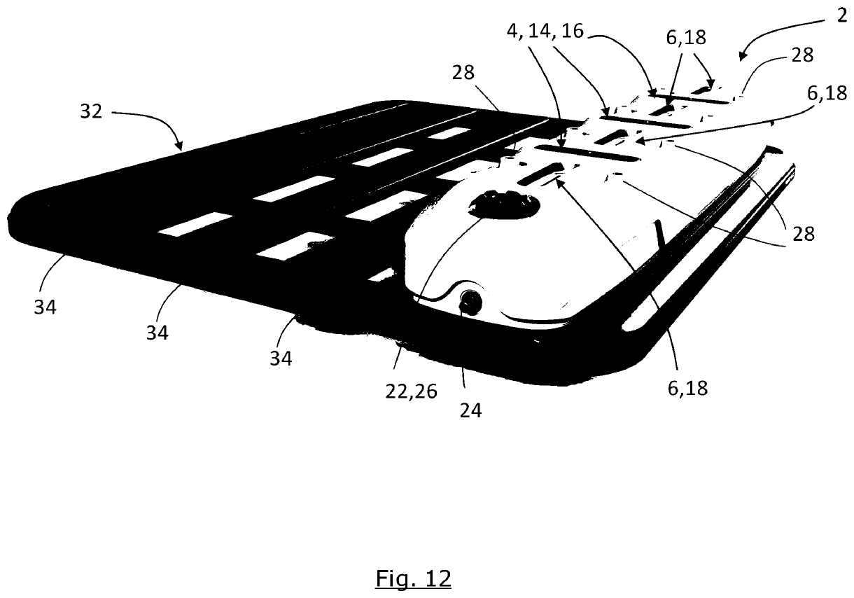

The fluid container 2 is preferably formed so as to be elongated, preferably elongated to be substantially the length of the roof of the vehicle on which it is mounted, and further can be mounted such that a longitudinal axis of the fluid container 2 is roughly parallel to the direction of travel as illustrated in FIGS. 11 and 12. The width of the fluid container 2 can be roughly a third to a half of the width of the vehicle roof which allows for other items, such as camping supplies, to be carried on the rooftop on a platform such as those exemplified in FIGS. 11 and 12. In the illustrated embodiments, the fluid container 2 is 154 cm in length, 30 cm wide and 15.5 cm in height, and carries 45 L of fluid. However it can be appreciated that the fluid container 2 can be mounted in various orientations on the vehicle, for example, such as being oriented such that the longitudinal axis of the fluid container 2 is transverse to the direction of travel or at an angle to the direction of travel. Further, the dimensions of the fluid container 2 can also vary to suit the user's desires, to accommodate lesser or greater volumes of fluid, to accommodate the varying vehicle dimensions or for aerodynamic purposes.

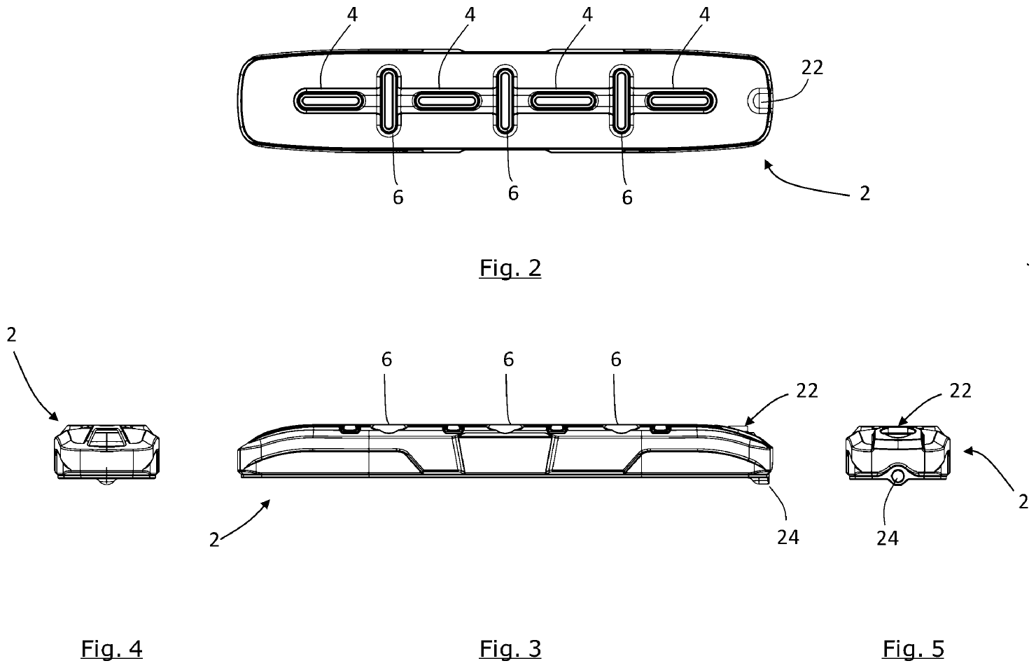

The overall profile of the fluid container 2 is configured for reducing drag when the vehicle is travelling and preferably is aerodynamically shaped. For example, as particularly illustrated in FIGS. 2 and 3, the upper and side surfaces of the fluid container 2 taper towards the ends. Therefore the fluid container 2 is configured to be mounted in any orientation or position, for example, with the inlet and outlets at the rear so as to present a more aerodynamic profile, although the inlet/outlet can be mounted at the front if so desired or on either side of the rooftop without increasing drag. Furthermore the fluid container 2 is configured so that it does not substantially increase the height of the vehicle when so mounted, for example the fluid container 2 may only be 15 to 20 cm in height, which advantageously keeps the centre of gravity of the vehicle low to promote handling stability and control.

In the embodiment illustrated in FIGS. 1 to 12, there are four spaced-apart slotted passageways 4 which are oriented such that they are elongated along the longitudinal axis of the fluid container 2. If the fluid container 2 is located such that it is parallel to a side of the vehicle with the inlet/outlet at a front of the roof, the slotted passageways 4 form baffles 8 for inhibiting movement of the fluid transverse to the longitudinal axis of the fluid container 2, and subsequently, inhibition of fluid movement transverse to the direction of travel. Three transversely oriented slotted passageways 6 intermediate to each pair of adjacent longitudinal passageways 4 therefore inhibits the fluid movement parallel to the longitudinal axis of the fluid container 2, and subsequently, parallel to the direction of travel. This arrangement of internal baffling being in alternating orientations advantageously provides effective minimisation of the fluid movement which promotes optimal control and stability of the vehicle and minimises fuel consumption especially during turning and braking. The baffle arrangement as shown most particularly in FIG. 9 will be appreciated as being only one of various arrangements of baffles, and the fluid container 2 may have one or any number of baffles which are oriented in different directions for inhibiting fluid movement.

The slotted passageways 4, 6 are also able to receive mounting means which allows the fluid container 2 to be mounted to the vehicle, preferably the of the vehicle although it can be appreciated that the fluid container 2 could be mounted in other locations such as a tray of a utility vehicle or by other mounting means which would be known by a person skilled in the art. In a preferred arrangement illustrated in FIGS. 11 and 12, the roof has a platform 32 which has channel or gutter arrangements 34 configured for attachment of rooftop items. It is also preferred that the mounting means allows the fluid container 2 to be easily attached or detached if required but when so attached ensures that the fluid container 2 is securely mounted. It is also anticipated that the mounting means may include locking arrangements such as a padlock or the like which prevents unauthorised removal of the fluid container.

In the illustrated embodiment, the mounting means is in the form of a washer member and a fastening arrangement which is receivable through the washer member 14 and slotted passageway 4, 6 to attach the fluid container 2 to the platform 32. In preferred examples, the fastening arrangements comprise male and female components such as a bolt 16 engageable to a threaded hole member (not shown) which is held in the channel or gutter arrangement 34 or a rod held upright in the channel or gutter 34 and on which the fluid container 2 can be mounted by the slotted passageway 4, 6 and secured by a nut or bolt.

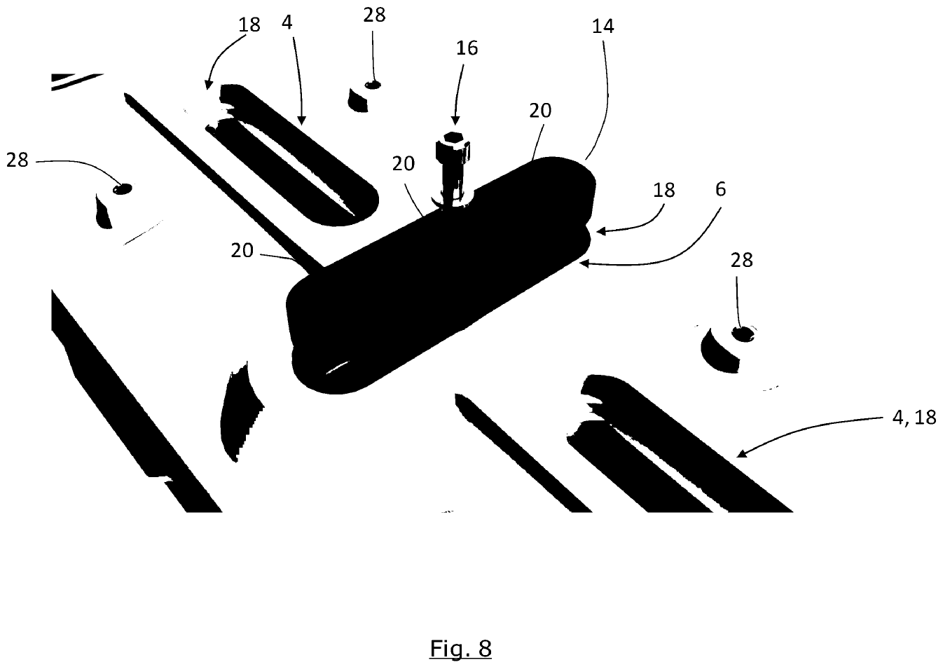

The washer member 14 is configured to be seated in a recess 18 at an upper portion of each slotted passageway 4, 6, and having a slot 20 configured to allow penetrable engagement of the shaft of the bolt 16 or rod. The slot 20 allows adjustment of positioning of the fluid container 2 as the bolt 16 or rod can be positioned anywhere along the slot 20 yet is also able to hold the fluid container 2 firmly when the fastening means is locked. In a particularly preferred embodiment, the washer member 14 can have three slots 20 as illustrated in FIG. 8 instead of the single slot 20. To preserve the aerodynamic profile of the fluid container 2 the washer member 14 and fluid container 2 are configured to receive the washer member 14 and bolt 16 in recessed engagement such that they do not protrude above the contoured surface. The washer member 14, as illustrated in FIG. 8, can comprise a polymer material.

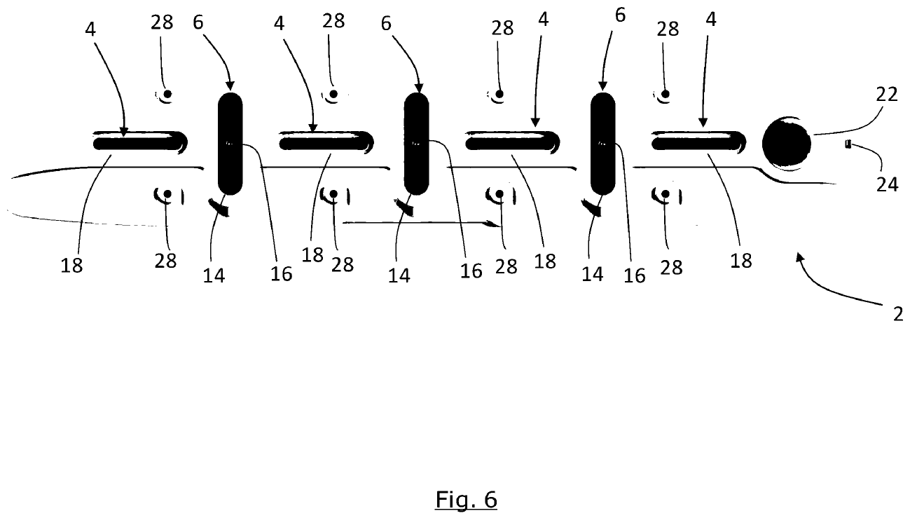

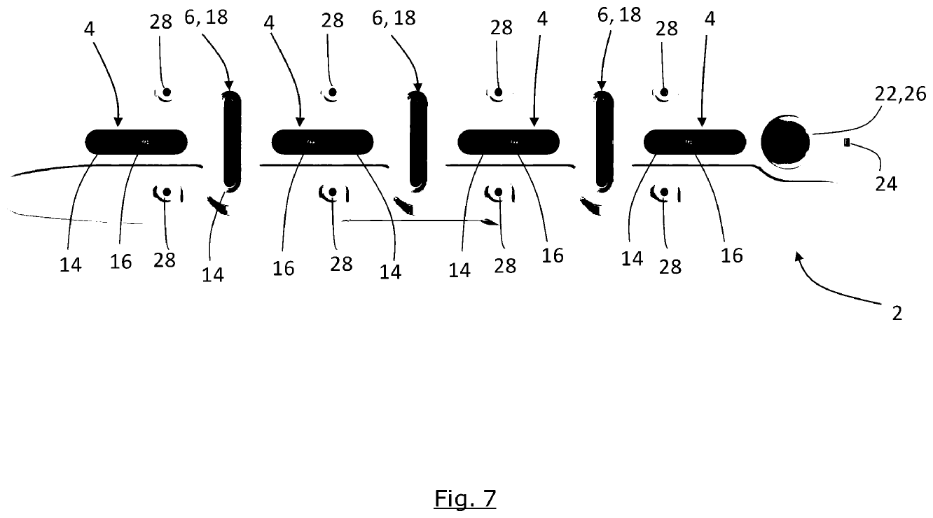

FIGS. 6 and 7 show two preferred ways of mounting. In FIG. 6, the fluid container 2 is secured by mounting means in engagement by the longitudinally oriented slotted passageways 4 while FIG. 7 shows the securement by the transversely oriented slotted passageways 6. This allows the positioning of the fluid container 2 to be varied in the longitudinal or transverse directions as selectable by the user before locking of the mounting means. It can be appreciated that the attachment of fluid container 2 to the vehicle can be via use of the slotted passageways 4, 6 regardless of orientation.

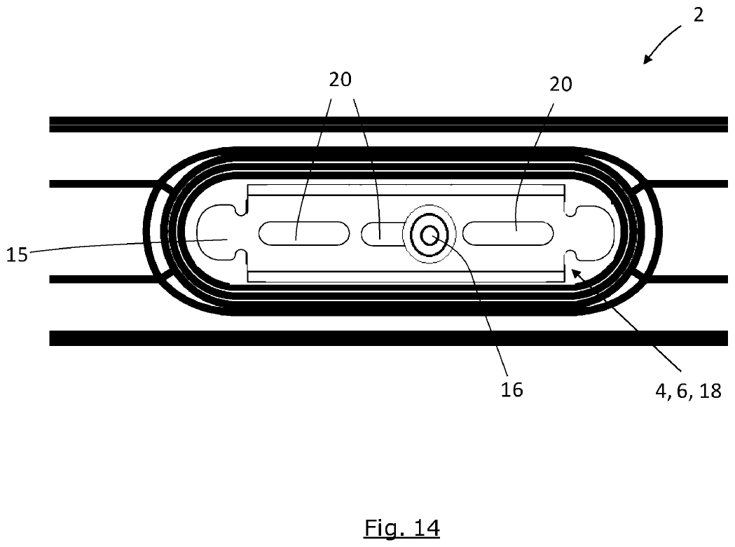

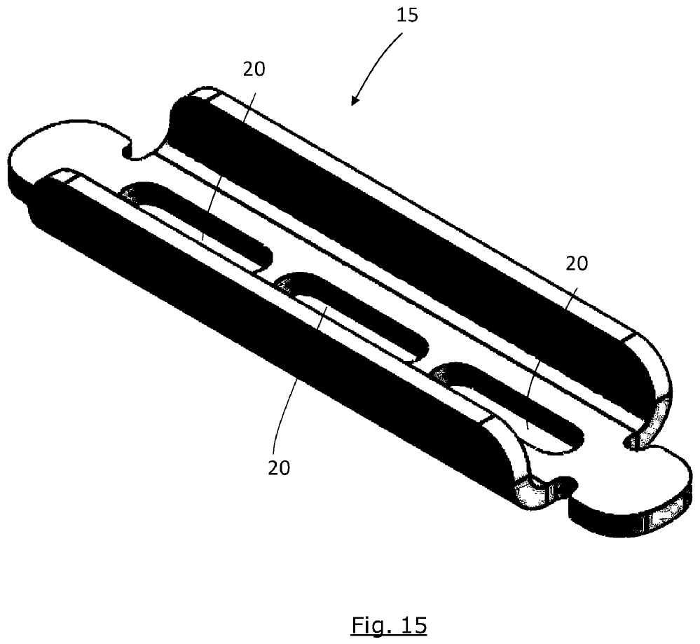

In another preferred embodiment illustrated in FIGS. 14 and 15, there is shown an alternative mounting arrangement having a washer member 15 which is also configured to be seated in a recess 18 of each slotted passageway 4, 6. This washer member 15 acts to perform the same or similar function as the washer member 14 however this washer member is comprised of metal and therefore less material is required while providing more strength and resilience against the external environment.

The above paragraphs describe a preferred method of mounting the fluid container via the use of washer members 14 however it can be appreciated that this fluid container 2 is also configurable to easily allow mounting to the vehicle via a variety of methods and mounting means. In particular, it would be understood that a person skilled in the art would be able to mount the fluid container 2 via a variety of methods and mounting means via any commercially available platforms or trays via mounting means that are already in common use. For example, mounting methods which do not require attachment points are also envisaged by the applicant. In one example, the fluid container can be mounted to a roof-bar or a portion of a platform or rack on the vehicle roof by one or more fastening means such as a U-bolt.

The fluid container 2 has an inlet 22 and outlet 24 for allowing the fluid, such as fuel or water, to fill the fluid container 2 and be dispensed therefrom. The inlet 22 is located on the upper surface of the fluid container 2 and preferably has a threaded outer portion on its periphery for receiving a screwable cap 26 although it will be appreciated that other closures may be used. The inlet 22 is recessed such that the cap 26 does not protrude above the surface profile of the fluid container 2 thereby reducing drag. The outlet 24 can be located at an end portion of the fluid container 2 and preferably, as illustrated in FIG. 9, at a recessed lower portion of the fluid container 2 for promoting dispensing of the fluid. The outlet 24, as illustrated in FIG. 9, preferably has a fitting which allows connection to a hose, such as those commonly used as garden hoses, which can then be directed to the opening of the vehicle's fuel tank for re-fuelling or for convenient dispensing of water. The outlet 24 can also preferably include a valve, for example a ball valve to allow dispensing of the fluid on demand.

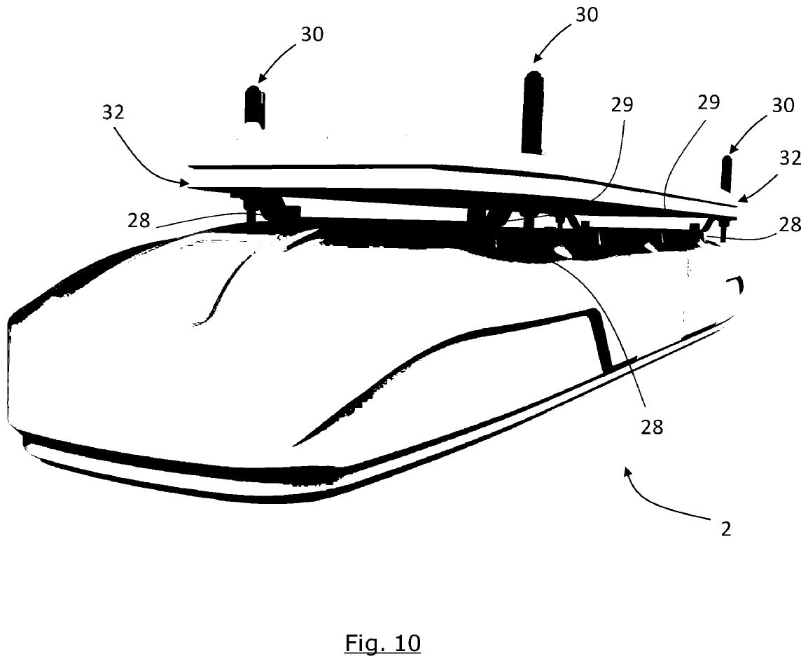

The fluid container 2 also has a plurality of attachment points 28 for easy and convenient mounting of other accessories which may be useful to the vehicle's owner. In the embodiment illustrated in FIGS. 10 and 11, a pair of mounting plates 29 can be attached to the attachment points 28 which are in the form of threaded holes which can receive fastening means (not shown) such as bolts or screws. Fastening means 30, in the example shown in the form of upright rods, pins or bolts on which a pair of recovery boards 32 can be mounted to the mounting plates 29. It can be appreciated that the attachment points 28 could be in the form of other fastening means, such as clips or clamps, which would allow releasable attachment of the recovery boards 32 and that other accessories or even a second fluid container could be substituted for the recovery boards.

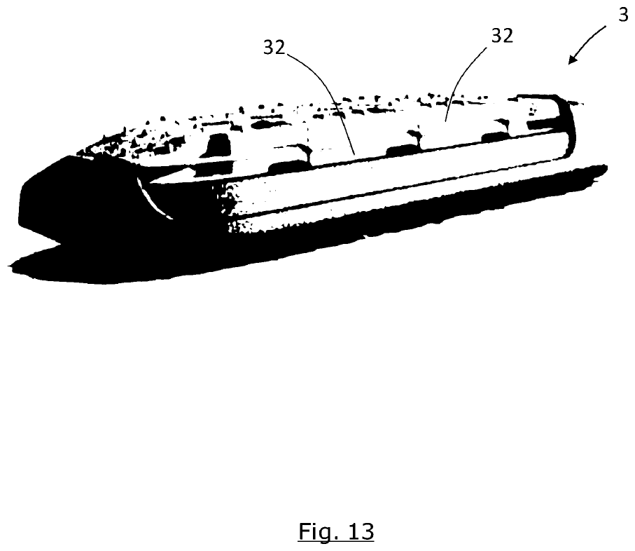

In a preferred embodiment illustrated in FIG. 13, there is shown a fluid container 3 which has been adapted so as to mount other equipment or accessories such as recovery boards 32. In particular, the upper surface of fluid container 3 is shaped so as to form a recess which is configured to fittably receive the recovery boards 32. This fluid container 3 therefore can easily carry a pair of recovery boards and also the overall shape formed by the fluid container 3 and the recovery boards when so received advantageously forms a surface profile which is aerodynamic. Therefore both equipment and the fluid container 3 can be mounted on the vehicle roof easily and which also reduces drag.

The fluid container 2 is preferably formed of material such as steel, aluminium or polymer material and which is also suitable for the fluid type which it may carry. It will be understood by the person skilled in the art that any type of fluid could be carried by the fluid container 2 including water and fuel. In particular, if the fluid is water, the fluid container 2 and/or lining is preferably formed of a food-grade safe and robust material such as a polymer material, for example, a UV resistant food grade polyethylene which is suitable for potable water. Similarly if the fluid container 2 is for containing fuel, the container may be formed of steel, aluminium or polymer material which is suitable for containing and storing fluid fuels, such as petrol, diesel or kerosene.

Through-out the specification and claims the word “comprise” and its derivatives is intended to have an inclusive rather than exclusive meaning unless the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the assembly uppermost.

It will be appreciated by those skilled in the art that many modifications and variations may be made to the methods of the invention described herein without departing from the spirit and scope of the invention.

1. A fluid container for a vehicle, comprising:
a body having at least one passageway which extends therethrough between opposing faces of the body, the at least one passageway being configured to receive mounting means for attachably mounting the body on the vehicle and wherein the at least one passageway internal to the body is configured to inhibit movement of the fluid contained therein.

2. The fluid container according to claim 1, wherein the at least one passageway is elongated to form a slotted passageway which has a wall internal to the body thereby forming at least one baffle to inhibit movement of the fluid from one side of the baffle to the other.

3. The fluid container according to claim 2, wherein, when the body is so mounted, at least one baffle is arranged to inhibit movement of the fluid substantially parallel to the direction of travel.

4. The fluid container according to claim 3, wherein, when the body is so mounted, the at least one baffle is arranged to inhibit movement of the fluid substantially transverse to the direction of travel.

5. The fluid container according to claim 4, wherein the body has at least two spaced-apart baffles, adjacent ones of which are oriented in transverse directions to inhibit movement of the fluid both transverse and parallel to the direction of travel.

6. The fluid container according to claim 1, wherein, when the body is mounted on a roof of the vehicle, the at least one passageway is vertically oriented for receiving fastening means for engageable mounting on the vehicle.

7. he fluid container according to claim 6, wherein the fastening means comprises male components threadably receivable in female components of a rack or platform mounted on the roof or vice versa.

8. The fluid container according to claim 7, wherein the at least one passageway is configured to hold a washer member configured to allow the fastening means to securely mount the body via the passageway to the vehicle.

9. The fluid container according to claim 8, wherein the washer member has a slot for adjustable positioning of the fastening means.

10. The fluid container according to claim 9, wherein an upwardly directed opening of the at least one passageway is recessed for seating the washer member.

11. The fluid container according to claim 1, wherein the body has an outlet for dispensing said fluid therefrom and an inlet for allowing fluid to be received therein.

12. The fluid container according to claim 11, wherein the outlet is adapted to connect to a hose.

13. The fluid container according to claim 11, wherein the inlet is arranged to receive a cap.

14. The fluid container according to claim 1, wherein the body is configured to contain potable water.

15. The fluid container according to claim 1, wherein the body is configured to contain fuel.

16. The fluid container according to claim 1, wherein the body of the body has attachment points for attachably mounting equipment.

17. The fluid container according to claim 16, wherein the equipment includes recovery boards.

18. The fluid container according to claim 1 wherein the body has an outer surface configured to reduce drag.

19. The fluid container according to claim 18, wherein the outer surface of the body is adapted so as to form a recess for receiving equipment.

20. The fluid container according to claim 19, wherein the body and the equipment when so received in the recess forms a profile configured to reduce drag.
